(19) United States
(12) Patent Application Publication
(10) Pub. No.: US 2026/0343222 A1
(43) Pub. Date: Oct. 29, 2026

(54) System and Method for Device Authentication Using Acoustic Resonance Signatures

(71) Applicant: Robert Murtha, Savannah, GA (US)

(72) Inventor: Robert Murtha, Savannah, GA (US)

(21) Appl. No.: 19/191,394

(22) Filed: Apr. 28, 2025

(51) Int. Cl. H04W 12/06

(52) U.S. Cl. CPC H04W 12/06

(57) ABSTRACT

A system and method for device authentication and secure key exchange using acoustic resonance properties is disclosed. The system leverages controlled acoustic emissions and captures the resulting resonant response of a device or object to generate a unique, reproducible physical signature. This signature serves as a cryptographic primitive for verifying device authenticity and establishing secure communications without reliance on traditional digital certificates or stored keys. The method includes emitting acoustic signals across defined frequency ranges, recording the device's acoustic response, extracting distinguishing features from the resonance patterns, and generating a secure digital fingerprint. Environmental calibration and adaptive drift correction mechanisms are integrated to maintain reliability over time and in varied operational conditions. The system supports both embedded and external module configurations and enables secure pairing, continuous identity verification, and protection against cloning or spoofing attacks. Applications include, but are not limited to, Internet-of-Things (IoT) devices, mobile electronics, unmanned systems, and critical infrastructure authentication.

### FIELD OF INVENTION

The present invention relates to systems and methods for secure device authentication and key exchange, and more specifically to the use of acoustic signals and the resulting resonant properties of physical objects to generate unique digital fingerprints for verifying device identity.

### BACKGROUND

Traditional device authentication methods often rely on stored cryptographic keys, digital certificates, or centralized databases to verify identity and establish secure communication. While effective in many contexts, these approaches are vulnerable to various threats, including key interception, cloning attacks, device spoofing, and unauthorized access. Additionally, reliance on stored secrets introduces security management challenges, especially in distributed systems or environments with limited connectivity.

There is a growing need for alternative authentication mechanisms that leverage intrinsic physical properties of devices, reducing dependence on externally stored or transmitted secrets. Acoustic resonance properties, which naturally arise from a device's physical structure and material composition, provide an opportunity to generate unique, reproducible signatures without embedding or storing sensitive key material.

Existing solutions do not adequately capture or utilize device-specific acoustic characteristics for authentication purposes in a reliable, secure, and scalable manner. Accordingly, there exists a need for systems and methods that enable secure device authentication and key exchange based on acoustic resonance signatures.

### SUMMARY OF THE INVENTION

The present invention provides systems and methods for secure device authentication and key exchange based on acoustic resonance signatures. By emitting controlled acoustic signals toward a device and analyzing its unique resonant response, a reproducible digital fingerprint can be generated without relying on pre-stored cryptographic keys or digital certificates.

In one embodiment, an acoustic transmitter emits a signal across a predetermined frequency range. A corresponding acoustic receiver captures the device's resonant response, which is then processed to extract distinguishing resonance features. These features are used to generate a digital fingerprint uniquely associated with the physical structure and material properties of the device.

The system includes calibration and environmental drift correction mechanisms to ensure signature stability across varying operational conditions. This approach enables secure authentication, pairing, and key exchange for a wide range of devices, including mobile electronics, Internet-of-Things (IoT) devices, unmanned aerial systems (UAS), and other critical systems requiring robust identity verification.

The invention provides a decentralized, physically-rooted authentication mechanism that enhances security while reducing the risks associated with traditional key storage, transmission, and management.

### BRIEF DESCRIPTION OF THE DRAWINGS

FIG. 1 is a block diagram illustrating a core acoustic key exchange system, including an acoustic transmitter, target device, acoustic receiver, signal processor, signature generator, and authentication module.

FIG. 2 is a flowchart illustrating the authentication process using acoustic resonance signatures, including emission of an acoustic signal, capture of the resonant response, extraction of distinguishing features, generation of a digital fingerprint, and authentication of the device.

### DETAILED DESCRIPTION OF THE INVENTION

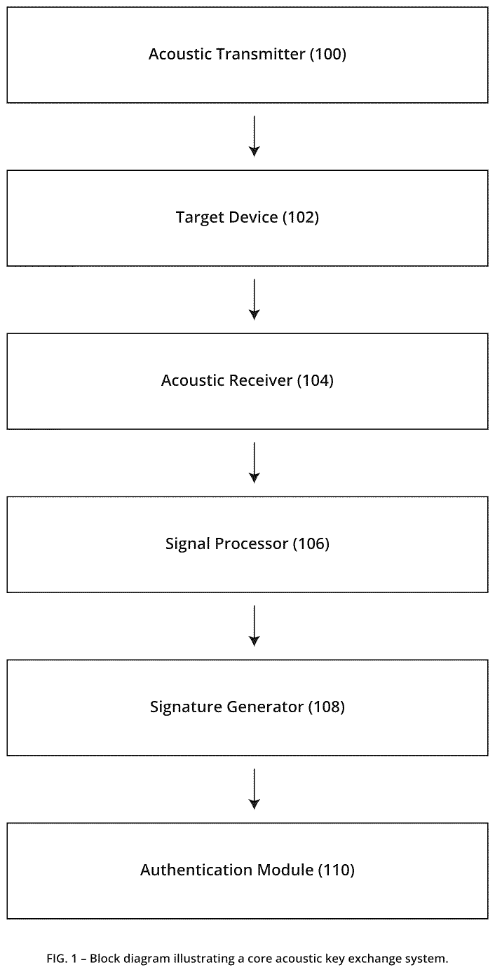

Referring now to FIG. 1, a block diagram illustrating an embodiment of a core acoustic key exchange system is shown. The system includes an acoustic transmitter 100 configured to emit controlled acoustic signals across a predetermined frequency range. The acoustic signals are directed toward a target device 102, which responds with a resonant acoustic profile determined by its unique physical characteristics, such as material composition, shape, and internal structure.

An acoustic receiver 104 captures the resonant response generated by the target device 102. The captured signal is provided to a signal processor 106, which analyzes the resonance features, including frequency peaks, phase shifts, amplitude variations, and other distinguishable properties.

The extracted features are transmitted to a signature generator 108, which produces a reproducible digital fingerprint uniquely associated with the target device 102. This digital fingerprint represents the physical resonance characteristics of the device without requiring the storage or transmission of pre-existing cryptographic keys.

An authentication module 110 uses the generated digital fingerprint to verify the authenticity of the target device 102 by comparing the fingerprint to previously recorded profiles. If the fingerprint matches an authorized identity, the system can securely establish a communication session, grant access, or perform other authentication-dependent operations.

Environmental calibration mechanisms may be incorporated to compensate for background noise, temperature shifts, humidity changes, or other factors that could affect the resonant response. The system may further include drift correction protocols to maintain the stability and reliability of the acoustic signatures over time.

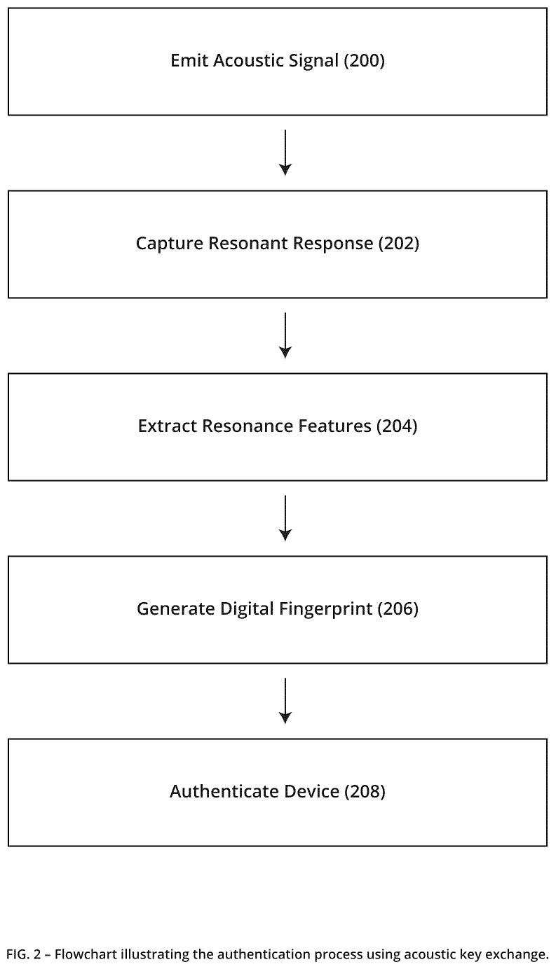

Referring now to FIG. 2, a flowchart illustrating an embodiment of the authentication process using acoustic resonance signatures is shown. At step 200, an acoustic signal is emitted toward the device under test by the acoustic transmitter 100. At step 202, the resonant response generated by the device is captured by the acoustic receiver 104.

At step 204, the signal processor 106 extracts distinguishing features from the captured resonant response. These features are analyzed to identify physical patterns unique to the device.

At step 206, a digital fingerprint is generated by the signature generator 108 based on the extracted features. The fingerprint is structured to be reproducible under similar conditions while being difficult to replicate or spoof.

At step 208, the authentication module 110 compares the generated fingerprint to a database of known, authorized fingerprints to determine the authenticity of the device. If a match is confirmed, the device is authenticated, and secure operations may proceed.

The described system and method enable decentralized, physically-rooted device authentication without the need for stored digital secrets or certificates, improving resilience against spoofing, cloning, and other attacks targeting conventional authentication systems.

What is claimed is:

1. A system for authenticating a device using acoustic resonance signatures, comprising:
an acoustic transmitter configured to emit an acoustic signal toward the device across a predetermined frequency range;
an acoustic receiver configured to capture a resonant acoustic response generated by the device in response to the acoustic signal;
a signal processor configured to extract resonance features from the captured resonant acoustic response, wherein the resonance features are indicative of intrinsic physical characteristics of the device including at least one of material composition, structural geometry, or internal configuration;
a signature generator configured to generate a reproducible digital fingerprint based on the extracted resonance features without relying on pre-stored cryptographic keys; and
an authentication module configured to authenticate the device by comparing the generated digital fingerprint to one or more reference fingerprints associated with authorized devices.

2. The system of claim 1, further comprising a calibration module configured to adjust at least one of the emitted acoustic signal or signal processing parameters based on detected environmental noise conditions.

3. The system of claim 1, wherein the signal processor is further configured to apply environmental drift correction to the extracted resonance features to compensate for changes in ambient conditions over time.

4. The system of claim 1, wherein the authentication module is further configured to establish a secure communication channel with the device following successful authentication.

5. The system of claim 1, wherein the device comprises at least one of an unmanned aerial system (UAS), an Internet-of-Things (IoT) device, a mobile computing device, or an industrial sensor.

6. The system of claim 1, wherein the acoustic transmitter is configured to emit multiple types of acoustic signals, including at least one of a frequency sweep, a chirp signal, or a pulsed emission pattern.

7. The system of claim 1, wherein the authentication module is further configured to perform continuous authentication by periodically re-verifying the resonant response of the device during an operational session.

8. The system of claim 1, wherein the signal processor is further configured to detect anomalies in the resonant acoustic response indicative of device tampering, structural modification, or unauthorized alteration.

9. The system of claim 1, wherein the signature generator is configured to periodically update the digital fingerprint based on recalibration of the device's acoustic profile.

10. The system of claim 1, wherein the digital fingerprint is encrypted prior to transmission for remote authentication purposes.

11. The system of claim 1, wherein the acoustic transmitter and acoustic receiver are integrated into a portable external module configured to authenticate a device without requiring modification of the device's internal components.

12. A method for authenticating a device using acoustic resonance signatures, comprising:
emitting an acoustic signal toward the device;
capturing a resonant acoustic response generated by the device;
extracting resonance features from the captured resonant acoustic response;
generating a digital fingerprint based on the extracted resonance features; and
authenticating the device by comparing the generated digital fingerprint to one or more stored fingerprints associated with authorized devices.

13. The method of claim 12, further comprising calibrating the emitted acoustic signal based on detected environmental noise conditions prior to emitting the acoustic signal toward the device.

14. The method of claim 12, further comprising applying environmental drift correction to the extracted resonance features to compensate for changes in ambient conditions over time.

15. The method of claim 12, wherein authenticating the device further comprises performing continuous authentication by periodically re-verifying the resonant acoustic response during an operational session.

16. The method of claim 12, further comprising detecting anomalies in the resonant acoustic response indicative of tampering or unauthorized modification of the device.

17. The method of claim 12, further comprising encrypting the generated digital fingerprint prior to transmitting or comparing the fingerprint for authentication purposes.

18. The method of claim 12, further comprising periodically updating the generated digital fingerprint based on recalibration of the device's acoustic profile.

19. A portable authentication module configured to authenticate a device using acoustic resonance signatures, comprising:
an acoustic transmitter configured to emit an acoustic signal toward the device;
an acoustic receiver configured to capture a resonant acoustic response generated by the device;
a signal processor configured to extract resonance features from the captured resonant acoustic response;
a signature generator configured to generate a digital fingerprint based on the extracted resonance features; and
a communication interface configured to output an authentication result based on a comparison of the generated digital fingerprint to one or more stored fingerprints associated with authorized devices.

20. The portable authentication module of claim 19, wherein the module is configured to operate using an internal battery.

21. The portable authentication module of claim 19, wherein the communication interface is configured to wirelessly transmit authentication results via Bluetooth, Wi-Fi, or other wireless protocols.

22. The portable authentication module of claim 19, further comprising a calibration module configured to adjust the emitted acoustic signal based on environmental noise conditions.

23. The portable authentication module of claim 19, wherein the module is configured to encrypt the generated digital fingerprint prior to outputting the authentication result.

24. The portable authentication module of claim 19, further comprising an internal memory configured to store authorized fingerprints for offline authentication.

25. The portable authentication module of claim 19, wherein the signal processor is further configured to detect anomalies in the resonant acoustic response indicative of tampering or unauthorized modification of the device.

26. A method for establishing secure communication with a device using acoustic resonance authentication, comprising:
emitting an acoustic signal toward the device;
capturing a resonant acoustic response generated by the device;
extracting resonance features and generating a digital fingerprint from the resonant acoustic response;
authenticating the device based on a comparison of the generated digital fingerprint to authorized fingerprints; and
establishing a secure communication session with the device upon successful authentication.

27. The method of claim 26, further comprising generating a session-specific encryption key based on the authentication result.

28. The method of claim 26, further comprising encrypting data transmitted during the secure communication session using the session-specific encryption key.

29. The method of claim 26, wherein generating the session-specific encryption key comprises incorporating elements of the generated digital fingerprint into the key derivation process.

30. The method of claim 26, further comprising authenticating both the initiating device and the responding device prior to establishing the secure communication session.

31. The method of claim 26, further comprising terminating the secure communication session if periodic re-authentication fails or if a predefined session timeout threshold is exceeded.

32. The method of claim 26, further comprising verifying an additional authentication factor, beyond the acoustic resonance signature, prior to establishing the secure communication session.

33. A system for detecting tampering of a device using acoustic resonance analysis, comprising:
an acoustic transmitter configured to emit an acoustic signal toward the device;
an acoustic receiver configured to capture a resonant acoustic response generated by the device;
a signal processor configured to detect anomalies in the resonant acoustic response relative to a baseline response indicative of unauthorized physical modifications to the device.

34. The system of claim 33, wherein the signal processor is configured to detect anomalies indicative of structural changes, material alterations, or unauthorized hardware modifications.

35. The system of claim 33, further comprising an alerting module configured to generate a security alert upon detection of an anomaly in the resonant acoustic response.

36. The system of claim 33, further comprising a logging module configured to record detected anomalies for subsequent forensic analysis.

37. The system of claim 33, wherein the signal processor is configured to determine the presence of an anomaly based on a predefined deviation threshold from the baseline resonant response.

38. The system of claim 33, wherein the signal processor is further configured to adaptively update the baseline resonant response using machine learning algorithms to accommodate authorized changes while maintaining tamper detection capabilities.

39. The system of claim 33, further comprising a security mechanism configured to protect the baseline resonant response profile from unauthorized access or modification.

40. The system of claim 1, wherein the acoustic signal comprises mechanical vibrations propagated through a solid, liquid, or gaseous medium.
